(19) United States
(12) Patent Application Publication
(10) Pub. No.: US 2007/0251362 A1
(43) Pub. Date: Nov. 1, 2007

(54) Device for processing workpieces using ultrasound and method for operating that device

(75) Inventor: Ulrich Vogler, Uhldingen (DE)

Correspondence Address: DREISS, FUHLENDORF, STEIMLE & BECKER, POSTFACH 10 37 62, D-70032 STUTTGART, omitted

(73) Assignee: Herrmann Ultraschalltechnik GmbH & Co.KG, Karlsbad-Ittersbach (DE)

(21) Appl. No.: 11/730,935

(22) Filed: Apr. 5, 2007

(30) Foreign Application Priority Data
Apr. 26, 2006 (DE) 102006020429.8-26
Aug. 24, 2006 (DE) 10 2006 041 655.4

(51) Int. Cl. B26D 1/00

(52) U.S. Cl. 83/13; 83/701

(57) ABSTRACT

A device for processing workpieces using ultrasound, comprises an ultrasound oscillating structure and an anvil with a counter tool, wherein the ultrasound oscillating structure has an ultrasound sonotrode which can be moved by a carriage in the axial direction thereof and in the direction of the counter tool. A force storage is provided for the counter tool to urge the counter tool with a force towards the ultrasound sonotrode. The invention also concerns a method for operating such a device.

This application claims Paris Convention priority of DE 10 2006 020 429.8 filed Apr. 26, 2006 and DE 10 2006 041 655.4 filed Aug. 24, 2006 the complete disclosures of which are hereby incorporated by reference.

### BACKGROUND OF THE INVENTION

The invention concerns a device for processing workpieces using ultrasound, comprising a first tool part and a second tool part, wherein the first tool part can be moved by a carriage in the working direction thereof, and towards the second tool part.

Devices for processing workpieces are disclosed in EP-A 1 108 494, EP-A 1 466 709, DE-A 696 21 134, DE-U 295 07 068, DE-A 35 29 686, DE-A 197 16 018, WO-A 96 109 919, EP-A 1 112 823, DE-A 195 81 256, DE-A 44 39 284, WO-A 96 014 202, DE-A 10 2004 013 050, DE-A 10 2004 013 049 and DE-U 202 06 561. Devices of this type are used to process (in particular cut) thermoplastic materials, fabrics, paper and the like. It is thereby desired to reduce the cutting forces and/or optimize the cutting edge by using ultrasound.

One conventional technique is the free cut, wherein an ultrasound tool is designed as a cutting tool, and a material sheet or a workpiece is cut without a counter tool. The ultrasound tool, which is designed as an ultrasound knife, thereby moves relative to the workpiece in the direction of the cutting line. The ultrasound tool may also be designed as a rotating knife. In this case, an additional rotary movement is performed. This free cut is mainly used for cutting fabric webs. In this method, the cutting force results mainly from the cutting speed, the cutting geometry, the cutting angle and the workpiece itself.

A further conventional technique is the shaped cut with a counter tool, wherein an additional cutting pressure is generated between the ultrasound tool and the counter tool. In this fashion, cutting forces of almost any strength can be generated through either a force-dependent feed motion or via a fixed gap between the ultrasound tool and the counter tool. The workpiece to be processed is forced through this gap.

A further technique is the continuously formed cut. The ultrasound tool may thereby be designed as for a free cut, e.g. as an ultrasound knife. However, an additional force is exerted on the workpiece to be processed by urging the workpiece between the ultrasound knife and the counter tool. The cutting pressure is thereby considerably increased. The counter tool may thereby be designed as a simple plate or a rotating cylinder. The ultrasound tool may also be designed without a cutting geometry, wherein the cutting geometry is provided in the counter tool.

In a further conventional technique, a cycled cut is performed. A cutting force is thereby generated in cycles between the ultrasound tool and the counter tool. The cutting geometry may thereby be provided in the ultrasound tool and/or in the counter tool. In this method, the workpiece is processed in one, two or even three dimensions. An oscillating amplitude of the tool having a predetermined resonance frequency of e.g. between 20 and 60 kHz is applied to the workpiece and counter tool which is in addition to and which overlies the cutting force. The ultrasound tool moves by one stroke length towards the counter tool during the cycle. In this case, the counter tool is rigidly installed and does not move. When the ultrasound tool and the counter tool contact, the workpiece is usually separated. The ultrasound tool may also be rigidly clamped and the force and travel path may be performed by the counter tool. In both variants, one tool is rigidly clamped and the feed motion and cutting force is provided by the other tool.

The travel path may also be limited. This can be effected e.g. using an end stop that can be exactly adjusted, or through carriages which can be exactly positioned and fixed, and are driven e.g. by a spindle having a servomotor. This permits adjustment of a certain weld gap. When the workpiece must be completely separated, this weld gap is adjusted to zero or almost zero.

These techniques have proven to be problematic in that, when the workpiece has been separated, the ultrasound tool and the counter tool contact each other. The cutting force urges the surfaces together, which meet with the prevailing frequency of 20 to 60 kHz. This produces uncontrolled forces, motion and oscillations which are i.a. also audible. The ultrasound tool and also the counter tool are worn within a very short time due to notches and deformations that are formed in the contact surfaces. This wear can be reduced, but not completely prevented through hardening of the contact surfaces, e.g. through a coating or a harder steel. Moreover, only a limited number of materials or degrees of hardness may be used for ultrasound processing, since the materials which can be used for the tools are very limited. The cutting quality greatly decreases with increasing wear of the tool. For this reason, the tool must be frequently replaced.

Electronic regulation is feasible to reduce wear, and has partially been realized. However, fast switching-off of the ultrasound, fast cancellation of the cutting force or fast removal of the ultrasound tool from the counter tool cannot prevent contact. There are still a relatively large number of contacts due to the high frequency of the ultrasound tools. If e.g. during processing with a frequency of 20 kHz, the return motion of the ultrasound tool is started within 1 ms, there will still be 20 contacts between the ultrasound tool and the counter tool during this 1 ms.

Moreover, it has turned out to be difficult to exactly adjust the ultrasound tool relative to the counter tool in order to solve the contact problem, since the position of the components relative to each other is influenced by a plurality of variables. When e.g. the ultrasound tool is heated, the gap height changes due to expansion which has a direct effect on the cutting quality. Other variables are the ambient temperature, the process temperature, force fluctuations etc.

It is therefore the underlying purpose of the invention to provide a device for processing workpieces using ultrasound and/or a method for operating such a device that improves the cutting quality and prolongs the service life of the tools.

### SUMMARY OF THE INVENTION

This object is achieved in accordance with the invention with a device for processing workpieces using ultrasound of the above-mentioned type in that a force storage is provided for the second tool part which loads the second tool part towards the first tool part with a force (FS).

The first tool part is thereby an oscillating ultrasound structure with an ultrasound sonotrode or an anvil with a counter tool, and the second tool part is an anvil with a counter tool or an ultrasound oscillating structure with an ultrasound sonotrode.

The inventive device offers the substantial advantage that the counter tool is not rigidly held, but exerts a force in the direction of the ultrasound sonotrode which means that the counter tool can give way even when this force is exceeded by the ultrasound sonotrode. When the clearance changes e.g. due to temperature fluctuations, the counter tool either follows or gives way to the ultrasound sonotrode, thereby maintaining high cutting quality and considerably reducing the wear on the working surfaces of the tools.

In a further development, the force of travel of the carriage is greater than the feed force of the force storage, in particular, by a factor of 1.2 to 5.0, preferably 1.5 to 2.0. For this reason, the counter tool gives way and not the ultrasound sonotrode when the ultrasound sonotrode is supplied and/or the workpiece is inserted between the ultrasound sonotrode and the counter tool. This prevents damage to the working surfaces. The force of travel of the carriage is thereby at least 50N, in particular 200N to 5000N, preferably 800N to 2000N.

In accordance with the invention, the force storage is a pneumatic and/or hydraulic spring or a magnet, in particular, an electromagnet. The force to be provided by the force storage is thereby dimensioned to be much smaller than the force of travel of the carriage or of the ultrasound sonotrode, wherein the force provided by the force storage represents the cutting force.

Typical cutting forces range from 10N to 2000N. The cutting forces thereby increase with increasing thickness of the workpiece. The force storage formed by the mechanical spring may e.g. be a spiral spring, a plate spring or a leaf spring. In particular, the force of the force storage can be adjusted to desired values.

In accordance with a preferred embodiment, the resonance frequency of the anvil with counter tool is smaller than the resonance frequency of the oscillating structure, in particular by a factor 10² to 10⁴, preferably by a factor 10³. This design is substantially advantageous in that the working surface of the counter tool rests on the position of maximum deflection, i.e. at the apex of the working surface of the ultrasound sonotrode, since due to the low eigen frequency of the counter tool, the counter tool cannot follow the high-frequency motion of the ultrasound sonotrode. The eigen resonance of the anvil system is considerably smaller than the eigen resonance of the ultrasound oscillating structure, in particular, the ultrasound sonotrode. This prevents uncontrolled oscillation of the counter tool.

Oscillation is also advantageously reduced, when the anvil and, in particular, the force storage have a damping element for the counter tool. This damping element may also be generally disposed in the anvil system, e.g. as a damping element on the counter tool, in particular as a frictional damper. In another simple solution, the bearings are designed such that the bearing friction has the damping properties.

In accordance with a preferred embodiment, the ultrasound sonotrode and the counter tool can be moved exclusively coaxially towards each other. This is achieved through high-quality guidances within the ultrasound oscillating system and within the anvil system. The quality of the cut or welding is thereby substantially increased. The ultrasound sonotrode and/or the counter tool may thereby have a cutting edge and/or a welding edge.

In a further development, a fixed stop is provided for the carriage which moves the ultrasound sonotrode. This provides a defined feed and adjustment of the exact weld or cutting gap, and moreover optimally fixes the ultrasound sonotrode.

To further optimize the cutting speed and/or reduce wear of the tool, the transient time of the ultrasound system may be extended or the amplitude and/or cutting forces may be varied in dependence on time during the cut. At the end of the cut, the cutting force and/or the amplitude are e.g. reduced. Longer transient times are advantageous in view of wear, but prolong the cutting time.

The welding surfaces may additionally be provided in the same tool having the cutting edge, or additional tools having a welding surface may be provided.

The above-mentioned object is also achieved in accordance with the invention with a method for operating the above device, in that the ultrasound sonotrode moves the counter tool into a working position, in particular, via the workpiece, thereby exerting a feed force onto the workpiece.

The ultrasound sonotrode is thus fed until it contacts the workpiece and additionally also moves the counter tool, thereby pressing onto the workpiece with a predetermined feed force. During this process, the counter tool is moved by a working path. Deflection of the counter tool ensures that the workpiece, which is pressed onto the ultrasound sonotrode via the counter tool, is completely processed, in particular, completely separated. Temperature-related length changes can be neglected in the entire system. The small eigen frequency resulting from mass, spring rate and damping of the counter tool, prevents the working surfaces from being damaged, since the counter tool remains at the outermost apex of the ultrasound tool.

Further advantages, features and details of the invention can be extracted from the dependent claims and the following description which describes in detail two particularly preferred embodiments with reference to the drawing. The features shown in the drawing and mentioned in the description and the claims may thereby be essential to the invention either individually or collectively in arbitrary combination.

### BRIEF DESCRIPTION OF THE DRAWING

FIG. 1 shows a schematic structure of a first embodiment of the inventive device;

FIG. 2 shows a schematic structure of a second embodiment of the inventive device;

FIG. 3 shows a variant of the embodiment of FIG. 2; and

FIG. 4 shows a schematic structure of a third embodiment of the inventive device.

### DESCRIPTION OF THE PREFERRED EMBODIMENT

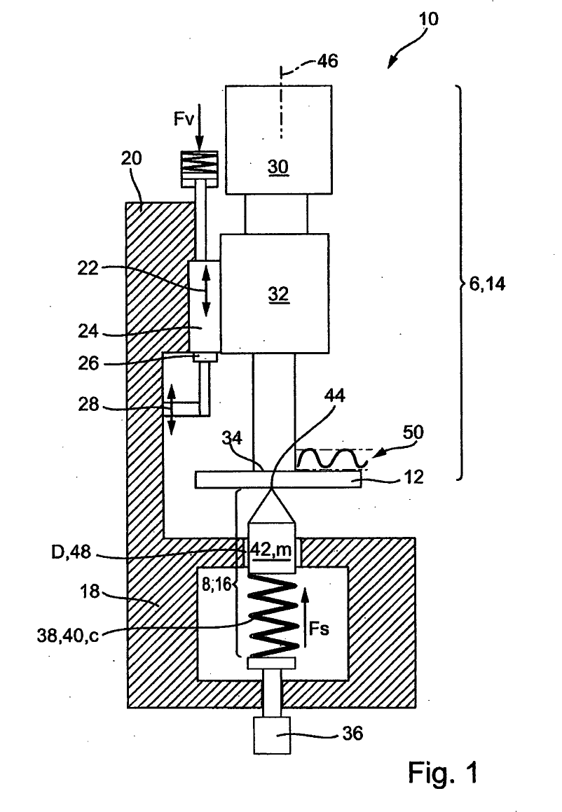

FIG. 1 shows a device for processing a workpiece 12 using ultrasound, which is designated in total with reference numeral 10. The device 10 consists of a first tool part 6, which is formed in FIG. 1 by an ultrasound oscillating structure 14, and a second tool part 8 which is formed by an anvil 16 which is disposed below the ultrasound oscillating structure 14. The anvil 16 is in a machine frame 18, to the arm 20 of which the ultrasound oscillating structure 14 is mounted by a carriage 24 which can be moved in the direction of the double arrow 22. The figure also shows a fixed stop 26 whose position can be adjusted in the direction of the double arrow 28. The ultrasound oscillating structure 14 has a converter 30 and an ultrasound sonotrode 32 whose working surface 34 is supported on the upper side of the workpiece 12. The anvil 16 is provided with an adjusting device 36 which is disposed in the machine frame 18. A force storage 40 formed by a mechanical spring 38, e.g. a helical spring, is mounted to the adjusting device 36, the force storage 40 bearing, in turn, a counter tool 42. The working surface 44 of the counter tool 42, which is shown as a cutting edge in the embodiment, abuts the lower side of the workpiece 12 and is located opposite to the working surface 34 of the ultrasound sonotrode 32.

The ultrasound oscillating structure 14 and anvil 16 have parallel axes, and are, in particular, coaxial to each other. The adjusting device 36 can press the counter tool 42 onto the workpiece 12 with a predetermined force, in particular, a feed force F_{A}. This feed force F_{S} is stored in the spring 38.

The figure also shows that the counter tool 42 is disposed in the machine frame 18 in a bearing 48, such that it can be moved in the direction of the vertical axis 46, wherein the bearing 48 has a bearing friction for damping D. The counter tool 42 has a mass m. The spring 38 moreover has a spring constant c, which results in a resonance frequency f_{A}=f(m,c,D) for the anvil 16 which is determined from the mass m of the counter tool 42, the spring constant c of the spring 38, and damping D of the bearing 48.

FIG. 1 also shows that the carriage 24 presses onto the fixed stop 26 with a travel force Fᵥ which can, in particular, be adjusted. The travel force Fᵥ is thereby substantially larger than the feed force F_{S}(Fᵥ>>F_{S}), such that the workpiece 12 is moved together with the counter tool 42 and the spring 38 is compressed and the force F_{S} is stored in the spring 38.

The function of the device 10 in accordance with FIG. 1 is described below. As mentioned above, the ultrasound oscillating structure 14 is moved by the carriage 24 in the direction of the anvil 16 until the working surface 34 of the ultrasound sonotrode 32 seats on the workpiece 12. The ultrasound sonotrode 32 subsequently compresses the workpiece 12 together with the counter tool 42 in the direction of the adjusting device 36, i.e. downwards in FIG. 1, until the carriage 24 is seated on the fixed stop 26. This builds up a feed force or cutting force F_{S} in the spring 38, by which the working surface 44 abuts the lower side of the workpiece 12 and presses the workpiece 12 onto the working surface 34 of the ultrasound sonotrode 32.

The ultrasound sonotrode 32 is subsequently put into operation such that the working surface 34 oscillates with the adjusted ultrasound, as is indicated at 50. The workpiece 12 is thereby separated and the working surface 44 of the counter tool 42 penetrates into the workpiece 12. The cutting force F_{S} is provided only by the counter tool 42, since the ultrasound sonotrode 32 abuts the fixed stop 26.

As soon as the workpiece 12 has been separated, the working surfaces 34 and 44 temporarily contact, wherein, however, the counter tool 42 remains in this position. The counter tool 42 cannot follow the high-frequency oscillating working surface 34 of the ultrasound sonotrode 32, since the eigen frequency or resonance frequency of the counter tool 42 is substantially lower, in particular by a factor 10³, than the oscillating frequency of the ultrasound sonotrode 32. For this reason, the working surface 44 remains at rest. This can be obtained through suitable selection of the mass m, the spring constant c and damping D. Since contact between the working surfaces 34 and 44 cannot be prevented, they have a hardness of at least 55 HRC, which also prevents excessive wear thereof.

In one variant, the working surface 44 of the counter tool 42 is designed not only as a cutting edge but also has a welding surface, such that the counter tool 42 can be used to both cut and weld. In this fashion, workpieces 14 that consist of several layers can be simultaneously cut and the individual layers can be welded together. This is desirable in particular for hose bag systems, wherein the individual hose bags are filled and subsequently separated.

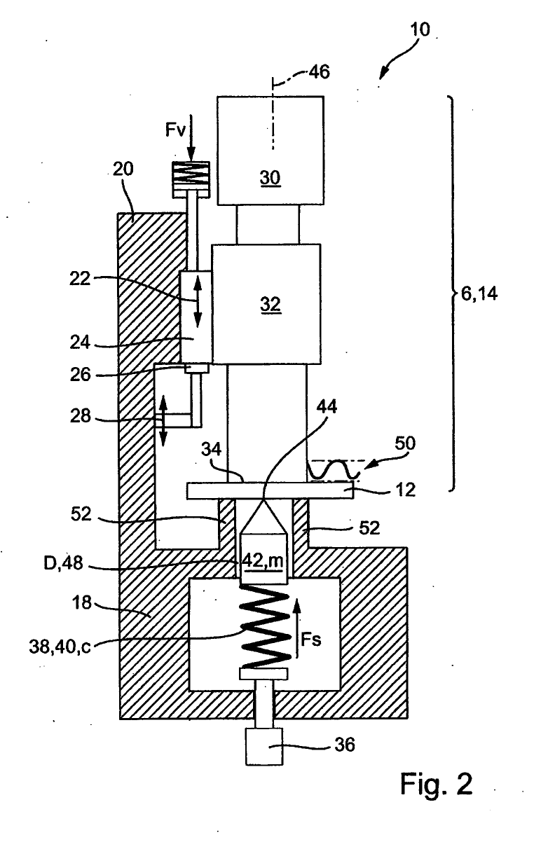

The anvil of FIG. 2 has a cutting edge 44 and a welding edge 52, wherein the welding edge 52 is mounted e.g. to the machine frame 18. The workpiece 12 is then welded and additionally cut. The cutting edge 44 which is sensitive and must be protected is resiliently disposed.

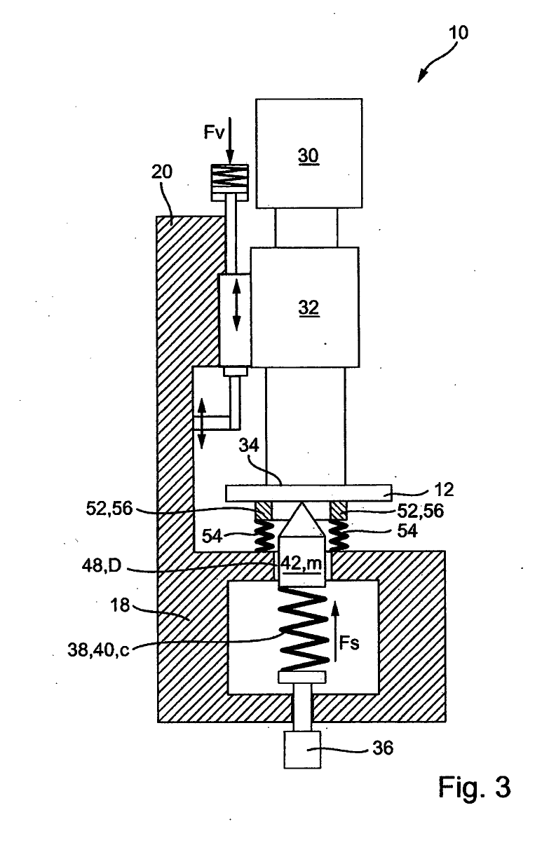

FIG. 3 shows a variant of the device 10 in accordance with FIG. 2. The workpiece 12 is thereby also simultaneously welded and cut. The anvil 18 has welding edges 52 which are resiliently disposed in this case. The associated springs 54 have welding elements 56 that abut the workpiece 12. This variant is advantageous in that it offers a certain flexibility and adaptivity relative to the workpiece 12 and the sonotrode 32. Exact parallel orientation of the anvil relative to the sonotrode 32 is thereby no longer required. The spring force and/or spring rigidity (C) of the welding elements 56 or welding edge 52 is much larger than the spring force and/or spring stiffness (c) of the counter tool 42. Mechanical springs, such as spiral springs, plate springs, or hydraulic or pneumatic springs or springs of elastic materials such as rubber, cork or the like may be used as springs 54.

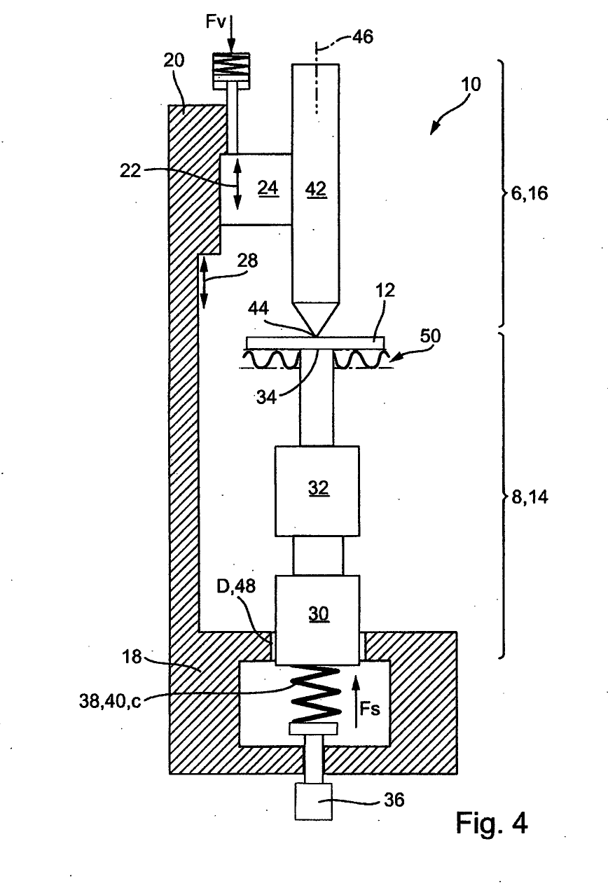

FIG. 4 shows a third embodiment of the invention, wherein the device 10 has a first tool part 6 which is formed in this case by an ultrasound oscillating structure 14, and comprises a second tool part 8, which is formed by an anvil 16 which is disposed above the ultrasound oscillating structure 14. The structure corresponds moreover substantially to that of FIG. 1.

The converter 30 and the ultrasound sonotrode 32 have a mass m. The spring 38 has moreover a spring constant c. This yields a resonance frequency f_{U}=f(m,c,D) for the ultrasound oscillating structure 14, which is determined from the mass m of the converter 30 and the ultrasound sonotrode 32, the spring constant c of the spring 38 and damping D of the bearing 48.

I claim:

1. A device for processing a workpiece using ultrasound, the device comprising:
a first tool part;
a second tool part;
a carriage cooperating with said first tool part to move said first tool part in a working direction towards said second tool part; and
means for force storage cooperating with said second tool part to urge said second tool part, with a feed force, towards said first tool part.

2. The device of claim 1, wherein one of said first tool part and said second tool part comprises an ultrasound oscillating structure with an ultrasound sonotrode and an other one of said first tool part and said second tool part comprises an anvil with a counter tool.

3. The device of claim 1, wherein a force of travel (Fᵥ) of said carriage is larger than said feed force (F_{S}) of said force storage means, exceeds said force storage means by a factor of 1.2 to 5.0, or exceeds said forces storage means by a factor of 1.5 to 2.0.

4. The device of claim 1, wherein a force of travel (Fᵥ) of said carriage is at least 50N.

5. The device of claim 1, wherein said force storage means comprises a mechanical spring, a pneumatic spring, a hydraulic spring, a magnet, or an electromagnet.

6. The device of claim 2, wherein said anvil has a resonance frequency (F_{A}) which is smaller than a resonance frequency (f_{S}) of an ultrasound oscillating structure, is smaller than f_{S} by a factor of 10² to 10⁴, or is smaller than f_{S} by a factor of 10³.

7. The device of claim 2, wherein said force storage means for said counter tool comprises a damping element.

8. The device of claim 2, wherein said ultrasound oscillating structure has a resonance frequency (f_{S}) which is smaller than the resonance frequency (f_{A}) of said anvil, which is smaller by a factor of 10² to 10⁴, or which is smaller by a factor of 10³.

9. The device of claim 2, wherein said force storage means for said ultrasound oscillating structure comprises a damping element.

10. The device of claim 2, wherein said ultrasound sonotrode and said counter tool are constrained to move coaxially towards each other.

11. The device of claim 2, wherein said ultrasound sonotrode and/or said counter tool have a cutting edge and/or a welding edge.

12. The device of claim 11, wherein said cutting edge and/or said welding edge is/are resiliently disposed.

13. The device of claim 11, wherein said welding edge has a larger spring constant and/or spring force than said cutting edge.

14. The device of claim 11, wherein said welding edge is disposed on a machine frame.

15. The device of claim 11, wherein said carriage has a fixed stop.

16. A method for using the device of claim 1, wherein said first tool part moves said second tool part via the workpiece into an operating position, thereby exerting said feed force on the workpiece.

17. The method of claim 16, wherein said second tool part is thereby moved by a partial amount of a maximum travel path.

18. The method of claim 16, wherein a resonance frequency of said second tool part is selected such that it rests on an apex of a working surface of said first tool part when said first tool part oscillates.

19. The method of claim 16, wherein an amplitude and/or cutting forces vary with time during cutting.

20. The method of claim 19, wherein said cutting force and/or said amplitude is reduced towards an end of a cut.
